(19) United States
(12) Patent Application Publication
(10) Pub. No.: US 2013/0144836 A1
(43) Pub. Date: Jun. 6, 2013

(54) CANONICALIZATION OF UNIFORM RESOURCE IDENTIFIERS

(71) Applicants: Vladislav ADZIC, East Setauket, NY (US); Derek Mauro, Scarsdale, NY (US); Bryan Horling, Sunnyvale, CA (US); Ye Zhou, Hoboken, NJ (US)

(72) Inventors: Vladislav ADZIC, East Setauket, NY (US); Derek Mauro, Scarsdale, NY (US); Bryan Horling, Sunnyvale, CA (US); Ye Zhou, Hoboken, NJ (US)

(73) Assignee: GOOGLE INC., Mountain View, CA (US)

(21) Appl. No.: 13/151,870

(22) Filed: Jun. 2, 2011

(51) Int. Cl. G06F 17/30

(52) U.S. Cl. 707/634; 707/E17.005

(57) ABSTRACT

One or more server devices may obtain a stored resource identifier associated with a resource identifier collection. The one or more server devices may further access a document index that stores information about canonical resource identifiers, where the information relates a particular canonical resource identifier to one or more other resource identifiers; determine whether the canonical resource identifier differs from the stored resource identifier; and replace the stored resource identifier with the canonical resource identifier, when the canonical resource identifier differs from the stored resource identifier.

### BACKGROUND

Many techniques are available to users today to find information on the world wide web (“web”). For example, a user may access a document by clicking on a link that includes a uniform resource identifier (URI) associated with the document. Many collections of URIs may exist on the Internet. One example of a URI collection is a collection of bookmarks. If a user finds a document of interest, the user may save the document as a bookmark. The bookmark may store the URI associated with the document and the user may access the document at a later time by selecting the bookmark. However, a URI associated with a document may change. For example, the document may be moved to a different domain. Thus, a user may not be able to access the document via the bookmark if the URI associated with the document has changed. Outdated URI collections may negatively impact the user's browsing experience.

### SUMMARY

According to one aspect, a method, performed by one or more computer devices, may include obtaining, by at least one of the one or more computer devices, a stored uniform resource identifier (URI) associated with a particular resource and associated with a URI collection; accessing, by at least one of the one or more computer devices, a document index that stores information about canonical URIs, where the information relates a particular canonical URI to one or more other URIs; determining, by at least one of the one or more computer devices, whether the particular canonical URI, stored in the document index and associated with the particular resource, differs from the stored URI; and replacing, by at least one of the one or more computer devices, the stored URI with the canonical URI, when the canonical URI differs from the stored URI.

According to another aspect, a method, performed by one or more computer devices, may include obtaining, by at least one of the one or more server devices, one or more canonical uniform resource identifiers (URIs) from a document index, where the one or more canonical URIs have changed since a particular time period; obtaining, by at least one of the one or more server devices, one or more outdated URIs associated with particular ones of the one or more canonical URIs from the document index; generating, by at least one of the one or more server devices, a URI update that includes the one or more canonical URIs and the associated one or more outdated URIs; and providing, by at least one of the one or more server devices, the generated URI update to one or more subscribers to replace the one or more outdated URIs with the one or more canonical URIs.

According to yet another aspect, a method, performed by one or more computer devices, may include subscribing, by at least one of the one or more computer devices, to a uniform resource identifier (URI) updates service; receiving, by at least one of the one or more computer devices, a URI update from the URI updates service, where the URI update includes an old URI and a new URI associated with the old URI; determining, by the at least one of the one or more computer devices, whether the old URI is stored in a URI collection associated with the one or more computer devices; and updating, by the at least one of the one or more computer devices, the old URI to the new URI, when the old URI is stored in the URI collection.

According to yet another aspect, a system may include one or more server devices to obtain a stored resource identifier associated with a resource identifier collection; access a document index that stores information about canonical resource identifiers, where the information relates a particular canonical resource identifier to one or more other resource identifiers; determine whether the canonical resource identifier differs from the stored resource identifier; and replace the stored resource identifier with the canonical resource identifier, when the canonical resource identifier differs from the stored resource identifier.

According to yet another aspect, a system may include one or more server devices to obtain one or more canonical uniform resource identifiers (URIs) from a document index, where the one or more canonical URIs have changed since a particular time period; obtain one or more outdated URIs associated with particular ones of the one or more canonical URIs from the document index; generate a URI update that includes the one or more canonical URIs and the associated one or more outdated URIs; and provide the generated URI update to one or more subscribers to replace the one or more outdated URIs with the one or more canonical URIs.

According to yet another aspect, a non-transitory computer-readable medium, storing instructions executable by one or more processors, may include one or more instructions to subscribe to a uniform resource identifier (URI) updates service; one or more instructions to receive a URI update from the URI updates service, where the URI update includes an old URI and a new URI associated with the old URI; one or more instructions to determine whether the old URI is stored in a URI collection associated with the one or more computer devices; and one or more instructions to update the old URI to the new URI, when the old URI is stored in the URI collection.

### BRIEF DESCRIPTION OF THE DRAWINGS

The accompanying drawings, which are incorporated in and constitute a part of this specification, illustrate one or more embodiments described herein and, together with the description, explain these embodiments. In the drawings:

FIG. 1 is a diagram of an example environment in which systems and methods described herein may be implemented;

FIG. 2 is a diagram of example components of a client device or a server device according to an implementation described herein;

FIG. 3A is a diagram of example functional components of a client device according to an implementation described herein;

FIG. 3B is a diagram of example functional components of a document index server according to an implementation described herein;

FIG. 3C is a diagram of example functional components of a uniform resource identifier collection server according to an implementation described herein;

FIG. 3D is a diagram of example functional components of a uniform resource identifier updates publisher server according to an implementation described herein;

FIG. 4A is a diagram of example data fields that may be stored in a document index according to an implementation described herein;

FIG. 4B is a diagram of example data fields that may be stored in a user memory according to an implementation described herein;

FIG. 5 is a flowchart of a first example process for updating uniform resource identifiers according to an implementation described herein;

FIG. 6 is a flowchart of a second example process for updating uniform resource identifiers according to an implementation described herein;

FIG. 7 is a flowchart of a third example process for updating uniform resource identifiers according to an implementation described herein;

FIG. 8 is a flowchart of an example process for publishing uniform resource identifier updates according to an implementation described herein;

FIG. 9A is a flowchart of an example process for detecting and reporting an outdated uniform resource identifier according to an implementation described herein;

FIG. 9B is a flowchart of an example process for sending a notification about an outdated uniform resource identifier according to an implementation described herein;

FIG. 10 is a first example of updating uniform resource identifiers according to an implementation described herein;

FIG. 11 is a second example of updating uniform resource identifiers according to an implementation described herein; and

FIG. 12 is a third example of updating uniform resource identifiers according to an implementation described herein.

### DETAILED DESCRIPTION

The following detailed description of the invention refers to the accompanying drawings. The same reference numbers may be used in different drawings to identify the same or similar elements. Also, the following detailed description does not limit the invention.

A URI may include a string of characters that identifies a resource on a network, such as the Internet. A resource may include any entity with an identity which may be accessed or retrieved over a network connection, such as a document, an image, an audio file, a video file, a data feed, and/or any other type of resource. A common example of an URI may be a uniform resource locator (URL). A URL may correspond to a URI that, in addition to identifying a resource, specifies how to access, or act upon, the resource. For example, a URL of http://www.webpage.com may specify a document that may be accessed at a device with a network address of www.webpage.com using the Hypertext Transfer Protocol (HTTP).

Many collections of URIs exits on the Internet. Examples of URI collections may include URI click data collected by a search engine, a bookmark collection, a search history, a browser history, a collection of data feed subscriptions, a collection of podcast subscriptions, external links included in messages of a discussion group or a message board, links included in email or text messages sent or received by users, a collection of URIs included in a particular document (e.g., a document associated with a “links” title), and/or any other collection of one or more URIs.

A URI may become outdated, meaning that the resource associated with the URI can no longer be accessed via the URI. For example, a URI may become outdated when the resource is moved to a different location, a web site associated with the resource changes domain names or extensions, and/or when the resource is renamed. Large collections of URIs may include many URIs that are no longer valid. For example, a user may store a bookmark collection on a bookmark server and the bookmark server may store bookmark collections for many users. Thus, over time, the bookmark server may end up including many outdated URIs.

An implementation described herein may relate to canonicalization of URIs in a collection of URIs. Canonicalization of a URI may correspond to updating the URI to a canonical URI. A canonical URI may correspond to the most up-to-date version of the URI available in a reference collection of URIs, such as a document index. Furthermore, multiple URIs may identify the same resource, and one of the multiple URIs may be chosen as a canonical URI. For example, two URIs may identify the same resource, yet one URI may include characters that could be removed from the URI while still leaving the URI as a functioning URI. Examples of characters that could be removed include characters associated with session identifiers or other types of characters not necessary for identifying the resource.

In one implementation described herein, a computer device associated with a URI collection may scan a stored URI in the URI collection and contact a document index (or another reference collection of URIs) to determine a canonical URI for the stored URI. If the canonical URI differs from the stored URI, the stored URI may be replaced with the canonical URI. In one example, the computer device may include a server device that manages a particular URI collection. In another example, the computer device may include a client device that stores URIs.

A URI collection may include multiple instances of a same URI. For example, many users may store the same bookmark in their bookmark folder on a bookmark server. Thus, in another implementation described herein, the computer device may generate a unique list of URIs associated with the URI collection and may determine canonical URIs using the unique list of URIs. Once a canonical URI is determined for a particular URI in the unique list of URIs, the canonical URI may be propagated to other instances of the particular URI in the URI collection.

In yet another implementation described herein, a URI updates publisher device may obtain a list of URIs that have recently changed from the document index and provide URI updates at particular intervals to subscribers. A computer device, such as a bookmark server, may subscribe to the URI updates publisher device and may receive URI updates at particular intervals. The URI updates may include a list of outdated URIs together with corresponding canonical URIs.

Another implementation described herein may involve obtaining a canonical URI in response to a user selecting an outdated URI. For example, if a user clicks on a URI that is outdated, while using a browser application, the browser application, or an add-on application (e.g., a toolbar) associated with the browser application, may contact a document index (or a URI updates publisher device) to determine a canonical URI. The browser application may receive the canonical URI and may access the resource associated with the outdated URI without having to display an error message to the user. Additionally, the add-on application may report the outdated URI to a device that manages URI updates, such as a URI updates publisher device.

Another implementation described herein may include identifying a document that includes an outdated URI and sending a notification about the outdated URI to an owner or manager associated with the document. The notification may include a canonical URI obtained from the document index.

A “document,” as the term is used herein, is to be broadly interpreted to include any machine-readable and machine-storable work product. A document may include, for example, an e-mail, a web page or a web site, a file, a combination of files, one or more files with embedded links to other files, a news group posting, a news article, a blog, a business listing, an electronic version of printed text, a web advertisement, etc. In the context of the web (i.e., the Internet), a common document is a web page. Documents often include textual information and may include embedded information (such as meta information, images, hyperlinks, etc.) and/or embedded instructions (such as Javascript, etc.). A “link,” as the term is used herein, is to be broadly interpreted to include any reference to/from a document from/to another document or another part of the same document.

### EXAMPLE ENVIRONMENT

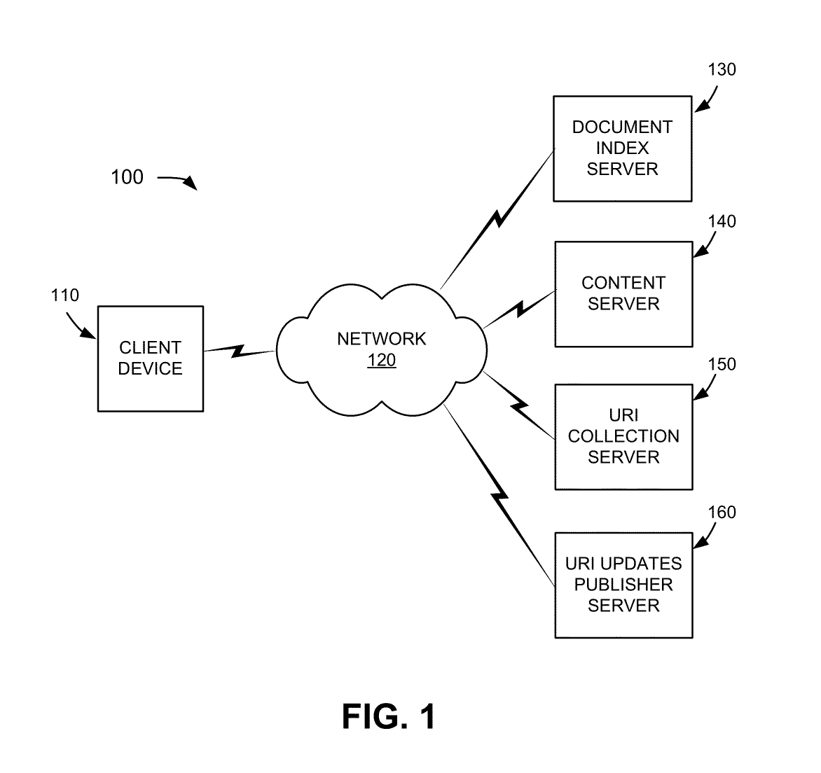

FIG. 1 is a diagram of an example environment 100 in which systems and/or methods described herein may be implemented. As shown in FIG. 1, environment 100 may include a client device 110, a network 120, a document index server 130, a content server 140, a URI collection server 150, and a URI updates publisher server 160. While FIG. 1 illustrates a single client device 110, a single document index server 130, a single content server 140, a single URI collection server 150, and a single URI updates publisher server 160 for the sake of clarity, in practice, environment 100 may include multiple client devices 110, multiple document index servers 130, multiple content servers 140, multiple URI collection servers 150, and multiple URI updates publisher servers 160.

Client device 110 may include a communication or computation device, such as a personal computer, a wireless telephone, a personal digital assistant (PDA), a lap top, or another type of computation or communication device. In one implementation, a client device 110 may include an application that enables documents to be accessed. Client device 110 may also include software, such as a plug-in, an applet, a dynamic link library (DLL), or another executable object or process, that may operate in conjunction with (or be integrated into) the application to implement canonicalization of URIs. Client device 110 may obtain the software from a particular software providing server device (not shown in FIG. 1), or from a third party, such as a third party server, disk, tape, network, CD-ROM, etc. Alternatively, the software may be pre-installed on client device 110. For the description to follow, the software will be described as integrated into the application.

In one example, the application may include a web browser running Hypertext Transfer Protocol (HTTP) and/or another protocol to access a document based on a URI, such as, for example, SPDY (a Transmission Control Protocol (TCP)-based application level protocol for transporting web content), File Transfer Protocol (FTP), BitTorrent protocol, and/or any other file transfer protocol. In yet another example, client device 110 may correspond to a mobile device and the application may include a program that uses a transfer protocol associated with an operating system running on the mobile device (e.g., Android or iOS).

Network 120 may include any type of network, such as a local area network (LAN), a wide area network (WAN), a metropolitan area network (MAN), a wireless network, such as a general packet radio service (GPRS) network, an ad hoc network, a telephone network (e.g., the Public Switched Telephone Network (PSTN) or a cellular network), an intranet, the Internet, or a combination of networks. Client device 110, document index server 130, content server 140, UI collection server 150, and/or URI updates publisher server 160 may connect to network 120 via wired and/or wireless connections.

Document index server 130 may include one or more devices (e.g., server devices) that manage a document index. A document index may associate query terms to documents. Document index server 130 may be associated with a search engine that matches query terms to documents. Furthermore, document index server 130 may include a crawler that browses documents on the Internet and determines up-to-date URIs associated with resources. The document index may associate a canonical URI with a resource and may also associate one or more current and/or outdated URIs with the canonical URI.

Content server 140 may include one or more devices (e.g., server devices) that may store one or more resources and/or that may provide content to client device 110. For example, a browser, at client device 110, may request a document associated with a particular URI, and a Domain Name Server (DNS) (not shown in FIG. 1) may translate the URI into an Internet Protocol (IP) address associated with content server 140. Client device 110 may then request the particular document from content server 140 and content server 140 may send information associated with the particular document to client device 110 across network 120. In one example, content server 140 may correspond to a host of a particular web site.

URI collection server 150 may include one or more devices (e.g., server devices) that are associated with a URI collection. For example, URI collection server 150 may include a bookmark server device that stores bookmarks associated with particular users, a bookmark server device that enables users to share and annotate bookmarks, a mail server device that stores messages sent or received by particular users, a short message service (SMS) server that stores text messages sent or received by particular users, a search history server device that stores search histories associated with particular users, a server device that stores data feed subscriptions for particular users, a server device that stores podcast subscriptions for particular users, a server device that stores messages posted in connection with a discussion group or message board, a server device that stores documents that include URIs, and/or any other computer device associated with a collection of URIs.

URI updates publisher server 160 may include one or more devices (e.g., server devices) that provide URI updates to subscribers. For example, URI updates publisher server 160 may contact document index server 130 to obtain a list of URIs that have been updated since a particular time, such as since a previous time when URI updates publisher server 160 has obtained a list of URIs from document index server 130. URI updates publisher server 160 may receive subscriptions from devices associated with a URI collection, such as URI collection server 150 and/or client device 110. URI updates publisher server 160 may generate a URI update based on the list of URIs obtained from document index server 130 and may send the update to the subscribers. The URI update may relate canonical URIs to outdated URIs.

Although FIG. 1 shows example components of environment 100, in other implementations, environment 100 may include fewer components, different components, additional components, or differently arranged components than depicted in FIG. 1. Additionally or alternatively, one or more components of environment 100 may perform one or more tasks described as being performed by one or more other components of environment 100. For example, in one example, one or more devices may perform the functions of both document index server 130 and URI updates publisher server 160.

### EXAMPLE DEVICES

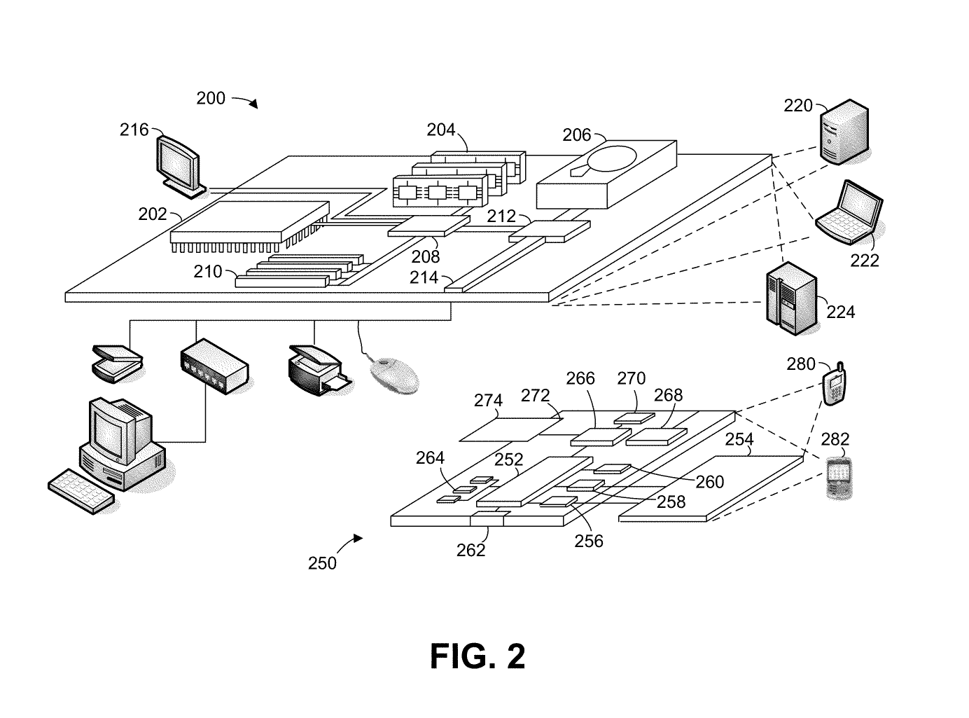

FIG. 2 is a diagram of example components of a generic computing device 200 and a generic mobile computing device 250, which may be used with the techniques described herein. Computing device 200 is intended to represent various forms of digital computers, such as laptops, desktops, workstations, personal digital assistants, servers, blade servers, mainframes, and other appropriate computers. Mobile computing device 250 is intended to represent various forms of mobile devices, such as personal digital assistants, cellular telephones, smart phones, and other similar computing devices. The components shown here, their connections and relationships, and their functions, are meant to be examples only, and are not meant to limit implementations described and/or claimed in this document.

Computing device 200 may correspond to client device 110, document index server 130, content server 140, URI collection server 150, and/or URI updates publisher server 160. For example, each of client device 110, document index server 130, content server 140, URI collection server 150, and/or URI updates publisher server 160 may include one or more computing devices 200. Mobile computing device 250 may correspond to client device 110 and/or to content server 140. For example, each of client device 110 and/or content server 140 may include one or more mobile computing devices 250.

Computing device 200 may include a processor 202, memory 204, a storage device 206, a high-speed interface 208 connecting to memory 204 and high-speed expansion ports 210, and a low speed interface 212 connecting to low speed bus 214 and storage device 206. Each of the components 202, 204, 206, 208, 210, and 212, may be interconnected using various busses, and may be mounted on a common motherboard or in other manners as appropriate. Processor 202 may process instructions for execution within computing device 200, including instructions stored in the memory 204 or on storage device 206 to display graphical information for a graphical user interface (GUI) on an external input/output device, such as display 216 coupled to high speed interface 208. In another implementation, multiple processors and/or multiple buses may be used, as appropriate, along with multiple memories and types of memory. Also, multiple computing devices 200 may be connected, with each device providing portions of the necessary operations (e.g., as a server bank, a group of blade servers, or a multi-processor system, etc.).

Memory 204 may store information within computing device 200. In one implementation, memory 204 may include a volatile memory unit or units. In another implementation, memory 204 may include a non-volatile memory unit or units. Memory 204 may also be another form of computer-readable medium, such as a magnetic or optical disk. A computer-readable medium may be defined as a non-transitory memory device. A memory device may include memory space within a single physical memory device or spread across multiple physical memory devices.

Storage device 206 may provide mass storage for computing device 200. In one implementation, storage device 206 may include a computer-readable medium, such as a floppy disk device, a hard disk device, an optical disk device, or a tape device, a flash memory or other similar solid state memory device, or an array of devices, including devices in a storage area network or other configurations. A computer program product may be tangibly embodied in an information carrier. The computer program product may also contain instructions that, when executed, perform one or more methods, such as those described below. The information carrier may include a computer- or machine-readable medium, such as memory 204, storage device 206, or memory included within processor 202.

High speed controller 208 may manage bandwidth-intensive operations for computing device 200, while low speed controller 212 may manage lower bandwidth-intensive operations. Such allocation of functions is an example only. In one implementation, high-speed controller 208 may be coupled to memory 204, display 216 (e.g., through a graphics processor or accelerator), and to high-speed expansion ports 210, which may accept various expansion cards (not shown). In the implementation, low-speed controller 212 may be coupled to storage device 206 and to low-speed expansion port 214. Low-speed expansion port 214, which may include various communication ports (e.g., USB, Bluetooth, Ethernet, wireless Ethernet) may be coupled to one or more input/output devices, such as a keyboard, a pointing device, a scanner, or a networking device, such as a switch or router, e.g., through a network adapter.

Computing device 200 may be implemented in a number of different forms, as shown in FIG. 2. For example, it may be implemented as a standard server 220, or multiple times in a group of such servers. It may also be implemented as part of a rack server system 224. Additionally or alternatively, computing device 200 may be implemented in a personal computer, such as a laptop computer 222. Additionally or alternatively, components from computing device 200 may be combined with other components in a mobile device (not shown), such as mobile computing device 250. Each of such devices may contain one or more of computing device 200, mobile computing device 250, and/or an entire system may be made up of multiple computing devices 200 and/or mobile computing devices 250 communicating with each other.

Mobile computing device 250 may include a processor 252, a memory 264, an input/output (I/O) device such as a display 254, a communication interface 266, and a transceiver 268, among other components. Mobile computing device 250 may also be provided with a storage device, such as a micro-drive or other device (not shown), to provide additional storage. Each of components 250, 252, 264, 254, 266, and 268, may be interconnected using various buses, and several of the components may be mounted on a common motherboard or in other manners as appropriate.

Processor 252 may execute instructions within mobile computing device 250, including instructions stored in memory 264. Processor 252 may be implemented as a set of chips that may include separate and multiple analog and/or digital processors. Processor 252 may provide, for example, for coordination of the other components of mobile computing device 250, such as, for example, control of user interfaces, applications run by mobile computing device 250, and/or wireless communication by mobile computing device 250.

Processor 252 may communicate with a user through control interface 258 and a display interface 256 coupled to a display 254. Display 254 may include, for example, a TFT LCD (Thin-Film-Transistor Liquid Crystal Display), an OLED (Organic Light Emitting Diode) display, and/or other appropriate display technology. Display interface 256 may comprise appropriate circuitry for driving display 254 to present graphical and other information to a user. Control interface 258 may receive commands from a user and convert them for submission to processor 252. In addition, an external interface 262 may be provide in communication with processor 252, so as to enable near area communication of mobile computing device 250 with other devices. External interface 262 may provide, for example, for wired communication in some implementations, or for wireless communication in other implementations, and multiple interfaces may also be used.

Memory 264 may store information within mobile computing device 250. Memory 264 can be implemented as one or more of a computer-readable medium or media, a volatile memory unit or units, or a non-volatile memory unit or units. Expansion memory 274 may also be provided and connected to mobile communication device 250 through expansion interface 272, which may include, for example, a SIMM (Single In Line Memory Module) card interface. Such expansion memory 274 may provide extra storage space for mobile computing device 250, or may also store applications or other information for mobile computing device 250. Specifically, expansion memory 274 may include instructions to carry out or supplement the processes described above, and may also include secure information. Thus, for example, expansion memory 274 may be provided as a security module for mobile computing device 250, and may be programmed with instructions that permit secure use of mobile computing device 250. In addition, secure applications may be provided via SIMM cards, along with additional information, such as placing identifying information on a SIMM card in a non-hackable manner.

Memory 264 and/or expansion memory 274 may include, for example, flash memory and/or NVRAM memory, as discussed below. In one implementation, a computer program product may be tangibly embodied in an information carrier. The computer program product may store instructions that, when executed, perform one or more methods, such as those described above. The information carrier may correspond to a computer- or machine-readable medium, such as the memory 264, expansion memory 274, or memory included within processor 252, that may be received, for example, over transceiver 268 or over external interface 262.

Mobile computing device 250 may communicate wirelessly through a communication interface 266, which may include digital signal processing circuitry where necessary. Communication interface 266 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 268. In addition, short-range communication may occur, such as using a Bluetooth, WiFi, or other such transceiver (not shown). In addition, a Global Positioning System (GPS) receiver module 270 may provide additional navigation- and location-related wireless data to mobile computing device 250, which may be used as appropriate by applications running on mobile computing device 250.

Mobile computing device 250 may also communicate audibly using an audio codec 260, which may receive spoken information from a user and convert it to usable digital information. Audio codec 260 may likewise generate audible sound for a user, such as through a speaker, e.g., in a handset of mobile computing device 250. Such sound may include sound from voice telephone calls, may include recorded sound (e.g., voice messages, music files, etc.) and may also include sound generated by applications operating on mobile computing device 250.

Mobile computing device 250 may be implemented in a number of different forms, as shown in FIG. 2. For example, it may be implemented as a cellular telephone 280. It may also be implemented as part of a smart phone 282, personal digital assistant (not shown), and/or other similar mobile device.

Various implementations of the systems and techniques described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) may include machine instructions for a programmable processor, and may be implemented in a high-level procedural and/or object-oriented programming language, and/or in assembly/machine language. As used herein, the terms “machine-readable medium” “computer-readable medium” may refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” may refer to any signal used to provide machine instructions and/or data to a programmable processor.

To provide for interaction with a user, the systems and techniques described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The systems and techniques described herein may be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system may be interconnected by any form or medium of digital data communication (e.g., a communication network). Examples of communication networks include a LAN, a WAN, and the Internet.

Although FIG. 2 shows example components of computing device 200 and mobile computing device 250, computing device 200 or mobile computing device 250 may include fewer components, different components, additional components, or differently arranged components than depicted in FIG. 2. Additionally or alternatively, one or more components of computing device 200 or mobile computing device 250 may perform one or more tasks described as being performed by one or more other components of computing device 200 or mobile computing device 250.

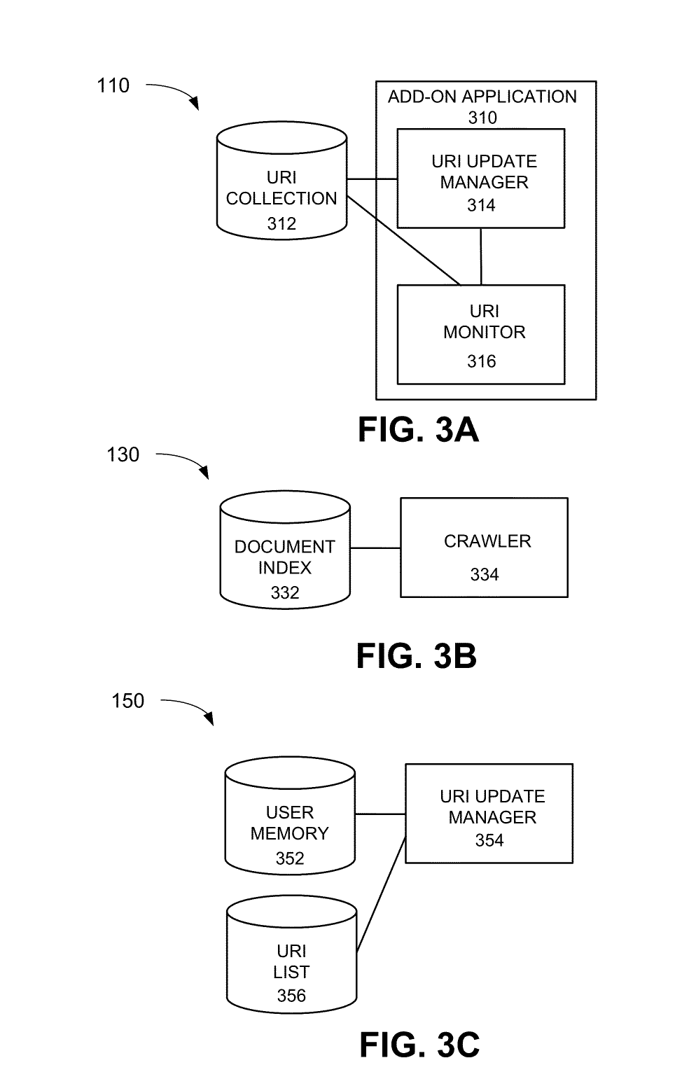

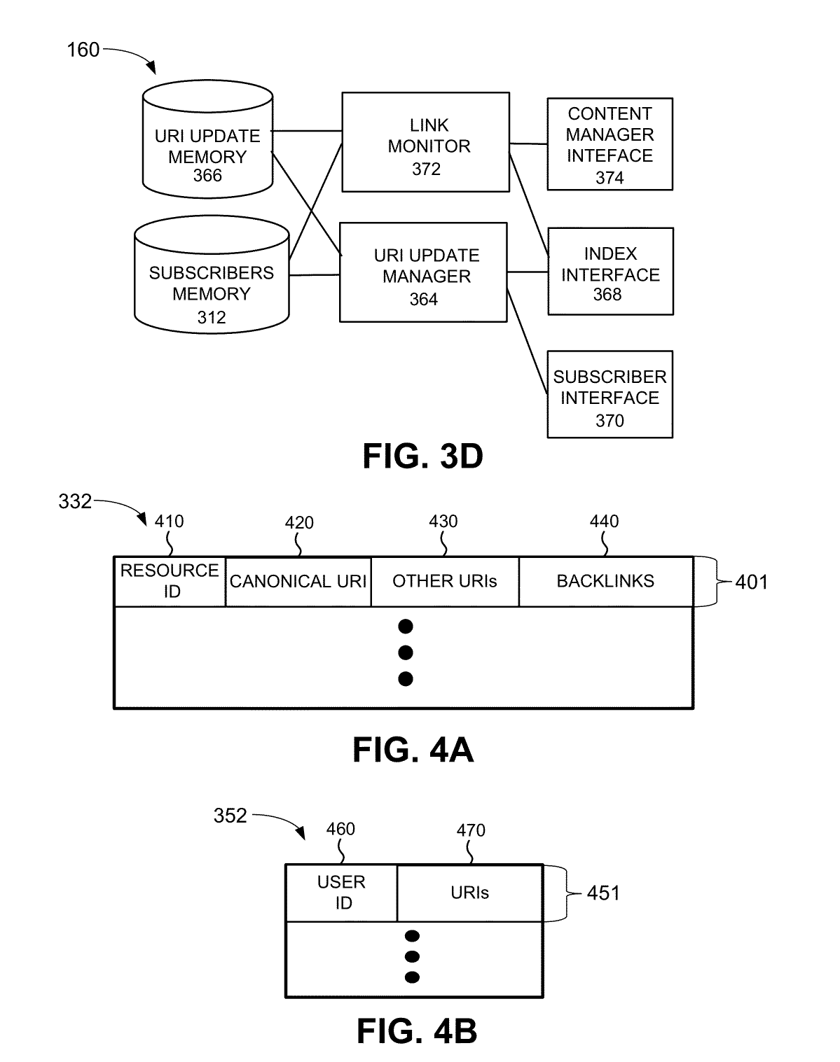

FIG. 3A is a diagram of example functional components of client device 110. As shown in FIG. 3A, client device 110 may include an add-on application 310, and a URI collection 312.

Add-on application 310 may be associated with a browser application and/or another application that accesses resources using URIs. In one example, add-on application 310 may be incorporated into a browser application (e.g., Google Chrome, Microsoft Explorer, Apple Safari, Mozilla Firefox, etc.). In another example, a user of client device 110 may be offered an option to install add-on application 310 by itself or as part of another application (e.g., a toolbar for a browser application). In one example, add-on application 310 may include one or more selectable visual elements, such as an option to activate or de-activate add-on application 310. In another example, add-on application 310, after obtaining the user's permission to activate, may not be associated with any selectable visual object and may function without interaction with the user.

Add-on application 310 may be associated with a URI collection 312 and may include a URI update manager 314 and a URI monitor 316.

URI collection 312 may store one or more URIs. In one example, URI collection 312 may include a bookmark collection associated with a browser application. In another example, URI collection 312 may include a browsing history associated with the browser application. In yet another example, URI collection may include URIs included in messages sent and/or received by the user of client device 110 in connection with a particular application, such as, for example, an email application, a text messaging application, and/or an instant messaging application.

URI update manager 314 may update URIs stored in URI collection 312 to canonical URIs based on information received from another device, such as document index server 130, URI collection server 150, and/or URI updates publisher server 160.

URI monitor 316 may monitor documents being accessed by client device 110 for outdated URIs. For example, if the user of client device 110 is browsing a document that includes links (e.g., URIs of other documents or other types of resources), URI monitor 316 may check whether the URIs included in the document are functioning. In one example, URI monitor 316 may attempt to access a resource associated with a URI included in the document, without providing the resource to an output device associated with client device 110, to determine whether the resource can be accessed. In another example, URI monitor 316 may contact document index server 130 to determine whether URIs included in the document are associated with canonical URIs that are different. URI monitor 316 may report any determined outdated URIs to a particular device, such URI updates publisher server 160.

Although FIG. 3A shows example functional components of client device 110, in other implementations, client device 110 may include fewer functional components, different functional components, additional functional components, or differently arranged functional components than depicted in FIG. 3A. Additionally or alternatively, one or more functional components of client device 110 may perform one or more tasks described as being performed by one or more other functional components of client device 110.

FIG. 3B is a diagram of example functional components of document index server 130. As shown in FIG. 3B, document index server 130 may include a document index 332 and a crawler 334.

Document index 332 may associate URIs with resources and may associate a canonical URI with one or more other URIs. Example fields that may be stored in document index 332 are described below with reference to FIG. 4A. Crawler 334 may attempt to access resources on the Internet using URIs. Crawler 334 may determine that a URI is outdated using one or more techniques, such as, for example, by detecting a redirect response (e.g., an HTTP 301 or 302 redirect response), by detecting a refresh redirect, by detecting particular text in a document (e.g., “please follow this link,” “this page has moved,” etc.), and/or by receiving a message from an owner of a resource that the URI associated with the resource has changed. Crawler 334 may determine a new canonical URI for the resource, based on, for example, information received from the redirect or information received from an owner of the URI. Crawler 334 may store the new canonical URI in document index 332.

Although FIG. 3B shows example functional components of document index server 130, in other implementations, document index server 130 may include fewer functional components, different functional components, additional functional components, or differently arranged functional components than depicted in FIG. 3B. Additionally or alternatively, one or more functional components of document index server 130 may perform one or more tasks described as being performed by one or more other functional components of document index server 130.

FIG. 3C is a diagram of example functional components of URI collection server 150. As shown in FIG. 3C, URI collection server 150 may include a URI memory 352, a URI update manager 354, and a URI list 356.

User memory 352 may store information associated with user accounts. Example fields that may be stored in user memory 452 are described below with reference to FIG. 4B. URI update manager 354 may update URIs stored in user memory 352 based on information obtained from document index server 130 and/or from URI updates publisher server 160. URI list 356 may include a list of unique URIs associated with user memory 352. For example, many user accounts may include the same URI. URI list 356 may facilitate updating of URIs to canonical URIs by enabling URI update manager 354 to only checking each unique URI once.

Although FIG. 3C shows example functional components of URI collection server 150, in other implementations, URI collection server 150 may include fewer functional components, different functional components, additional functional components, or differently arranged functional components than depicted in FIG. 3C. Additionally or alternatively, one or more functional components of URI collection server 150 may perform one or more tasks described as being performed by one or more other functional components of URI collection server 150.

FIG. 3D is a diagram of example functional components of URI updates publisher server 160. As shown in FIG. 3D, updates publisher server 160 may include a subscriber memory 362, a URI update manager 364, an index interface 368, a subscriber interface 370, a URI update memory 366, a link monitor 372, and a content manager interface 374.

Subscriber memory 362 may store information about subscribers that subscribe to a URI update service with URI updates publisher server 160. For example, subscriber memory 321 may store information (e.g., a network address and/or port number) associated with particular URI collection servers 150 (e.g., a bookmark server, a search history server, a mail server, etc.). In another example, if content server 140 includes documents which include many URIs, content server 140 may also subscribe to URI updates publisher server 160. For example, content server 140 may store news articles that include links to other news articles. News article documents may be associated with URIs that change often. Therefore, if content server 140 subscribes to URI updates publisher server 160, content server 140 may benefit by keeping URIs, included in documents hosted by content server 140, current. URI updates publisher server 160 may charge a subscription fee for the URI updates subscription service. In yet another example, client device 110 may subscribe to URI updates publisher server 160.

URI update manager 364 may contact document index server 130 to obtain canonical URIs that have recently changed (e.g., since the last time URI update manager 364 contacted document index server 130) via index interface 368 and may store the obtained URIs in URI update memory 366. URI update manager 364 may generate a URI update that includes information about URIs that have recently changed and may forward the generated URI update to subscribers via subscriber interface 370.

Index interface 368 may convert a request from URI update manager 364 into a particular format associated with document index server 130 and may convert messages received from document index server 130 into a particular format associated with URI update manager 364. Subscriber interface 370 may convert a URI update message into a particular format associated with a particular subscriber and may convert messages received from a particular subscriber into a particular format associated with URI update manager 364. URI update memory 366 may store information about URIs received from document index server 130.

Link monitor 372 may identify a document that includes a broken link, based on an indication of an outdated URI stored in URI update memory 366, and may send a notification to an owner or manager associated with the document. The notification may include a canonical URI that may be used to replace the outdated URI. Content manager interface 374 may convert a message from link monitor 372 into a particular format associated with an owner or manager of a document that includes a broken link.

Although FIG. 3D shows example functional components of URI updates publisher server 160, in other implementations, URI updates publisher server 160 may include fewer functional components, different functional components, additional functional components, or differently arranged functional components than depicted in FIG. 3D. Additionally or alternatively, one or more functional components of URI updates publisher server 160 may perform one or more tasks described as being performed by one or more other functional components of URI updates publisher server 160.

FIG. 4A is a diagram of example information that may be stored in document index 332. As shown in FIG. 4A, document index 332 may include one or more document records 401. A document record 401 may store information about a particular document. Document record 401 may include a resource identification (ID) field 410, a canonical URI field 420, an “other URIs” field 430, and a backlinks field 440.

Resource ID field 410 may store information identifying a particular resource. For example, resource ID field 410 may store a string that uniquely identifies the resource. Canonical URI field 420 may store a canonical URI associated with the resource. Other URIs field 430 may store one or more other URIs associated with the resource, such as an outdated URI. Backlinks field 440 may store information about documents that include a URI stored in canonical URIs field 420 and/or other URIs field 430. In other words, backlinks field 440 may store backlinks associated with the resource.

Although FIG. 4A shows example fields of document record 401, in other implementations, document record 401 may include fewer fields, different fields, additional fields, or differently arranged fields than depicted in FIG. 4A.

FIG. 4B is a diagram of example information that may be stored in user memory 352. As shown in FIG. 4B, user memory 352 may include one or more user records 451. A user record 451 may store information about URIs associated with a particular user. User record 451 may include a user ID field 460, and a URIs field 470.

User ID field 460 may store information identifying a particular user. For example, user ID field 460 may store a string that uniquely identifies the particular user. URI field 470 may store URIs associated with the particular user. For example, URI field 470 may store URIs associated with the particular user's bookmarks, URIs associated with the particular user's search history, URIs associated with messages sent or received by the particular user, etc.

Although FIG. 4B shows example fields of user record 451, in other implementations, user record 451 may include fewer fields, different fields, additional fields, or differently arranged fields than depicted in FIG. 4B.

### EXAMPLE PROCESSES

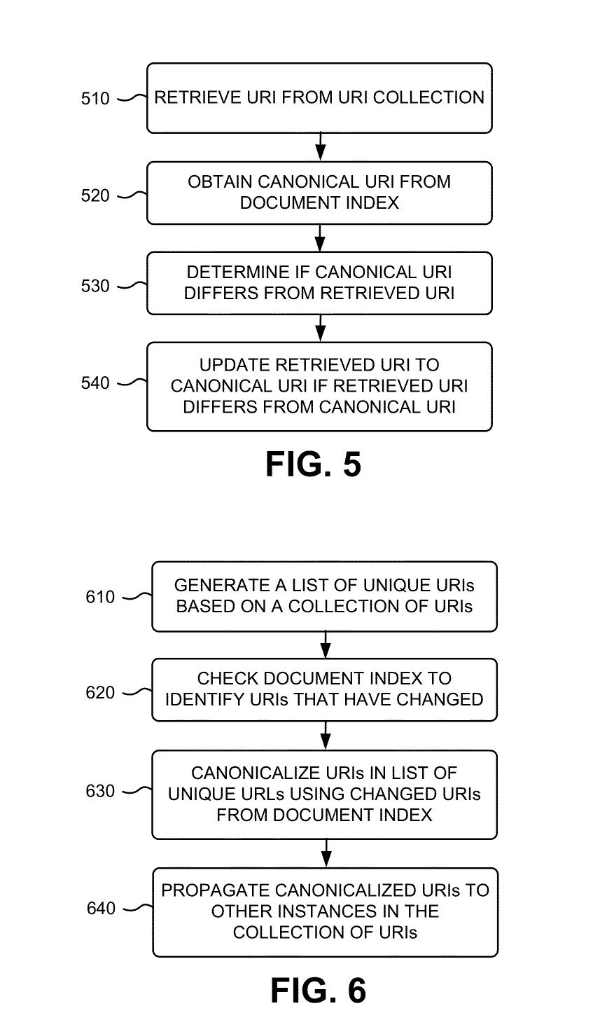

FIG. 5 is flowchart of a first example process for updating uniform resource identifiers according to an implementation described herein. In one implementation, the process of FIG. 5 may be performed by client device 110 or URI collection server 150. In other implementations, some or all of the process of FIG. 5 may be performed by another device or a group of devices separate and/or possibly remote from or including client device 110 or URI collection server 150.

The process of FIG. 5 may include retrieving a URI from a URI collection (block 510). For example, URI update manager 354 may perform a linear scan of URIs stored in user memory 352 and may retrieve a URI from user memory 352 to update the retrieved URI. AS another example, URI update manager 314 may perform a linear scan of URIs stored in URI collection 312. A canonical URI may be obtained from a document index (block 520). For example, URI update manager 354 (or URI update manager 314) may contact document index server 130 to determine a canonical URI associated with the retrieved URI. Document index server 130 may identify a resource record 401 that includes the retrieved URI stored in other URIs field 430 (and/or stored in canonical URI field 420), and may return a URI stored in canonical URI field 420 of resource record 401 associated with the retrieved URI.

A determination may be made if the canonical URI differs from the retrieved URI (block 530). For example, URI update manager 354 (or URI update manager 314) may compare the received canonical URI to the retrieved URI. The retrieved URI may be updated to the canonical URI if the canonical URI differs from the retrieved URI (540). For example, URI update manager 354 may update the retrieved URI to the canonical URI in URIs field 470 of user record 451 associated with the retrieved URI. As another example, URI update manager 314 may update the retrieved URI to the canonical URI in URI collection 312.

FIG. 6 is a flowchart of a second example process for updating uniform resource identifiers according to an implementation described herein. In one implementation, the process of FIG. 6 may be performed by client device 110 or URI collection server 150. In other implementations, some or all of the process of FIG. 6 may be performed by another device or a group of devices separate and/or possibly remote from or including client device 110 or URI collection server 150.

The process of FIG. 6 may include generating a list of unique URIs based on a collection of URIs (block 610). For example, URI update manager 354 may scan user memory 352 and may store each new URI in URI list 356. If URI list 356 already includes a particular URI scanned from user memory 352, URI update manager 354 may not add the particular URI to URI list 356. As another example, URI update manager 314 may scan client device 110 for URIs. For example, in addition to URI collection 312, client device 110 may include URIs stored in association with documents, URIs stored in association with a messaging program, URIs stored in documents saved in a browser cache, or any other URIs stored somewhere on client device 110. URI update manager 314 may generate a list of unique URIs (not shown in FIG. 3A) stored by client device 110.

A document index may be checked to identify URIs that have changed (block 620). For example, URI update manager 354 (or URI update manager 314) may compare a canonical URI associated with a particular URI from the list of unique URIs to determine whether the canonical URI differs from the particular URI. If the canonical URI differs from the particular URI, the particular URI may be identified as a URI that has changed.

URIs in the list of unique URIs may be canonicalized using changed URIs from the document index (block 630). For example, URI update manager 354 may change a particular URI, which has been identified as a URI that has changed, to a canonical URI associated with the particular URI. As another example, URI manager 314 may change a particular URI stored on client device 110, which has been identified as a URI that has changed, to a canonical URI associated with the particular URI.

The canonicalized URIs may be propagated to other instances in the generated list of URIs (block 640). For example, URI update manager 354 may propagate the canonicalized URI to other instances in the collection of URIs. For example, URI update manager 354 may determine instances of a particular URI, stored in URI list 356 and that has changed to a canonical URI, in user memory 352 and may change all instances of the particular URI in user memory 352 to the canonical URI. Thus, as an example, if 100 users have saved a URI “www.bookmark.com” as a bookmark, and the URI “www.bookmark.com” has been canonicalized to the URI “www.newbookmark.com,” URI update manager 354 may change the bookmark in the 100 user accounts that include the bookmark. As another example, URI update manager 314 may change all instances of a URI that has been canonicalized on client device 110. For example, assume client device 110 includes the URI “www.myhomepage.com” in a bookmark folder of a browser application, in an email message sent to a contact of the user of client device 110, and in a document composed by a word processing program. Further assume that the URI “www.myhomepage.com” has been canonicalized to “www.mynewhomepage.com.” URI update manager 354 may change all three instances of the URI “www.myhomepage.com” to “www.mynewhomepage.com.”

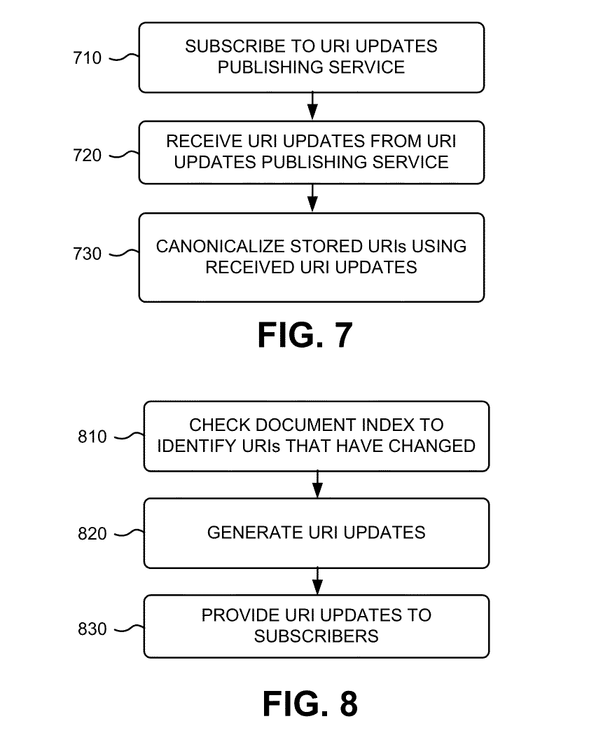

FIG. 7 is a flowchart of a third example process for updating uniform resource identifiers according to an implementation described herein. In one implementation, the process of FIG. 7 may be performed by client device 110 or URI collection server 150. In other implementations, some or all of the process of FIG. 7 may be performed by another device or a group of devices separate and/or possibly remote from or including client device 110 or URI collection server 150.

The process of FIG. 7 may include subscribing to a URI updates publishing service (block 710). For example, URI collection server 150 (and/or client device 110) may subscribe to URI updates publisher server 160. URI updates may be received from the URI updates publishing service (block 720). For example, URI collection server 150 (and/or client device 110) may receive a URI update from URI updates publisher server 160. The URI update may include a list of URIs that have changed since a previous URI update along with corresponding canonical URI. For example, an entry included in the URI update may include “www.oldURL.com has changed to www.newURL.com.” Stored URIs may be canonicalized using the received URI updates (block 730). For example, URI collection server 150 (and/or client device 110) may canonicalize stored URIs based on information received in the URI update.

FIG. 8 is a flowchart of an example process for publishing uniform resource identifier updates according to an implementation described herein. In one implementation, the process of FIG. 8 may be performed by URI updates publisher server 160. In other implementations, some or all of the process of FIG. 8 may be performed by another device or a group of devices separate and/or possibly remote from or including URI updates publisher server 160.

The process of FIG. 8 may include checking a document index to identify URIs that have changed (block 810). For example, URI update manager 364 may contact document index 332 at particular intervals and may scan document index 332 to determine new canonical URIs (e.g., URIs that have changed since a previous time when URI update manager 364 contacted document index 332). URI update manager 364 may obtain a list of recently changed URIs and store the recently changed URIs in URI update memory 366.

URI updates may be generated (block 820). For example, URI update manager 364 may generate a URI update that includes a list of URIs that have changed since a previous URI update along with corresponding canonical URI. For example, an entry included in the URI update may include “www.oldURL.com has changed to www.newURL.com”. The generated URI updates may be provided to subscribers (block 830). For example, URI update manager 364 may retrieve a list of subscribers from subscribers memory 362 and may send the generated URI update to devices identified in the retrieved list of subscribers.

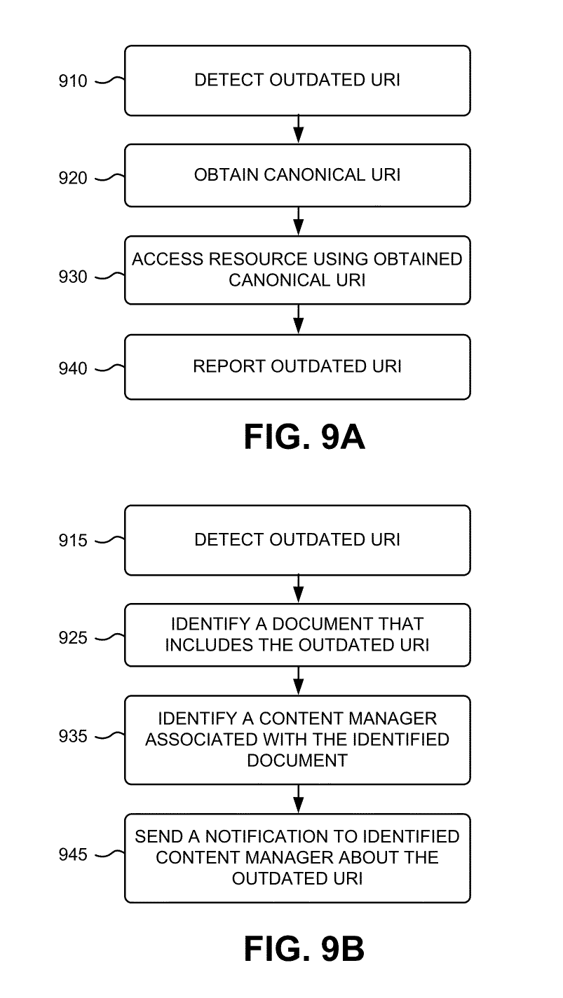

FIGS. 9A and 9B describe additional processes for handling an outdated URI. FIG. 9A is a flowchart of an example process for detecting and reporting an outdated uniform resource identifier according to an implementation described herein. In one implementation, the process of FIG. 9A may be performed by client device 110. In other implementations, some or all of the process of FIG. 9A may be performed by another device or a group of devices separate and/or possibly remote from or including client device 110.

The process of FIG. 9A may include detecting an outdated URI (block 910). For example, a user of client device 110 may attempt to access a resource using an outdated URI, such as a URI stored in a bookmark collection or a URI being displayed in a browser application window. The browser application may fail to access a resource and may generate an error message. A canonical URI may be obtained (block 920). For example, add-on application 310 may intercept the error message and may contact document index server 130 to determine a canonical URI associated with the detected outdated URI. Add-on application 310 may obtain a canonical URI, associated with the resource, from document index server 130.

The resource may be accessed using the obtained canonical URI (block 930). For example, add-on application 310 may instruct the browser application to access the resource using the canonical URI. Additionally, if the outdated URI is stored by client device 110, add-on application 310 may replace the stored outdated URI with the canonical URI.

The outdated URI may be reported (block 940). For example, add-on application may report the outdated URI to URI updates publisher server 160. Furthermore, in some situations, document index server 130 may not include a canonical URI. For example, a URI associated with a resource may have changed and crawler 334 may not have determined a new URI for the resource yet. In such situations, the browser application may generate an error message and add-on application 310 may report the outdated URI to document index server 130.

FIG. 9B is a flowchart of an example process for sending a notification about an outdated uniform resource identifier according to an implementation described herein. In one implementation, the process of FIG. 9B may be performed by URI updates publisher server 160. In other implementations, some or all of the process of FIG. 9B may be performed by another device or a group of devices separate and/or possibly remote from or including URI updates publisher server 160.

The process of FIG. 9B may include detecting an outdated URI (block 915). For example, URI updates publisher server 160 may contact document index server 130 and may obtain an indication of an outdated URI along with a new canonical URI associated with the outdated URI. As another example, URI updates publisher server 160 may receive a report from add-on application 310 running on client device 110 that an outdated URI has been detected based on browsing activity associated with the user of client device 110.

A document may be identified that includes the outdated URI (block 925). For example, link monitor 372 may access backlinks field 440 of document record 401 associated with the outdated URI to determine documents that include the outdated URI. A content manager associated with the identified document may be identified (block 935). For example, link monitor 372 may identify a manager or owner associated with the document that includes the outdated URI. In one example, contact information associated with the manager or owner associated with the document may be stored in backlinks field 440 or may be stored in another memory of documents. In another example, link monitor 372 may obtain contact information associated with the manager or owner by searching a domain associated with the document. Link monitor 372 may search the domain for terms indicative of contact information. For example, assume an outdated URI “www.outdatedURI.com” is included in a document identified by the URI “www.example-domain.com/link.html.” Link manager 372 may search www.example-domain.com for a URI that includes the term “contact” and may search a document associated with the URI for an email address.

A notification may be sent to the identified content manager about the outdated URI (block 945). For example, link monitor 372 may send a notification, via content manager interface 374, to an address associated with the determined content manager. The notification may include information identifying the outdated URI and may include a new canonical URI associated with the outdated URI.

### EXAMPLES

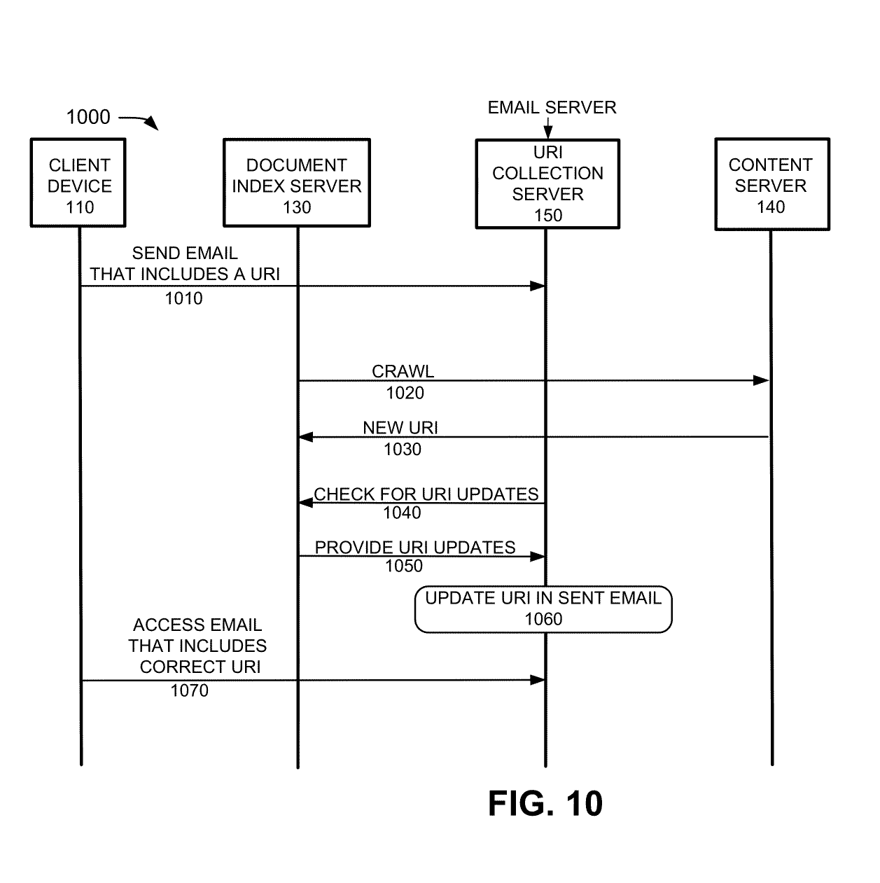

FIG. 10 is a first example 1000 of updating uniform resource identifiers according to an implementation described herein. In example 1000, URI collection server 150 may check with document index server 130 periodically to update URIs stored in association with URI collection server 150. In example 1000, URI collection server 150 may correspond to a mail server that stores messages sent and/or received by users. Assume that a user sends an email message via client device 110, where the email message includes a URI (signal 1010). For example, the user may be forwarding a link to a video file, stored on content server 140, to a friend. URI collection server 150 may store the email in the user's “sent emails” folder.

Document index server 130 may crawl content server 140 (signal 1020) and may determine that a new URI is associated with the video file (signal 1030). For example, content server 140 may have changed domain names or may have moved the video file to a different location. Document index server 130 may store the new URI as the canonicalized URI in connection with the video file.

URI collection server 150 may periodically check with document index server 130 for a list of URIs that have been updated (signal 1040). Document index server 130 may provide URI updates to URI collection server 150 (signal 1050). URI collection server 150 may update the URI associated with the video file as stored in the message in the user's “sent emails” folder (signal 1060). At a later time, the user may access the sent email and may select the updated URI included in the email, which may now correspond to the correct URI associated with the video file (signal 1070). Thus, the user may be able to access the video file from the sent email message, even though the URI associated with the video file has changed.

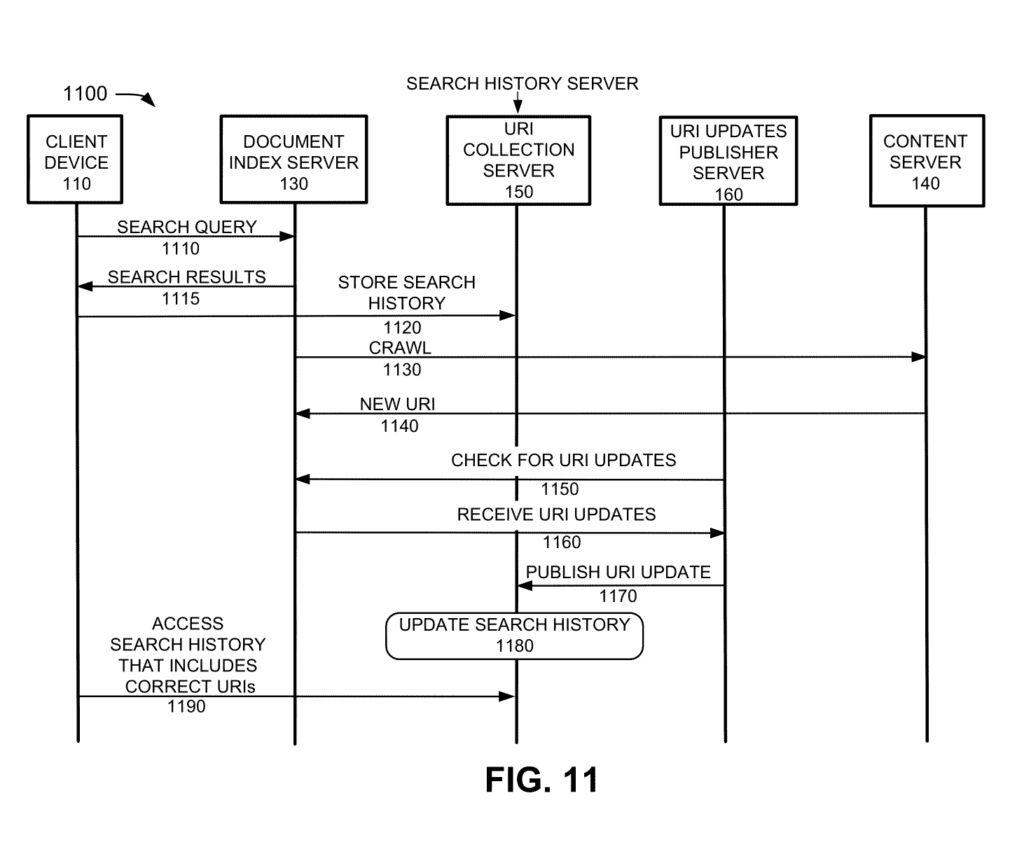

FIG. 11 is a second example 1100 of updating uniform resource identifiers according to an implementation described herein. In example 1100, URI updates publisher server 160 provides periodic URI updates to a subscriber. In example 1100, URI collection server 150 corresponds to a server that stores search histories associated with a user. Example 1100 may include a user sending a search query, via client device 110, to document index server 130 (signal 1110). Document index server 130 may search the document index based on the search query and may provide a list of search results to client device 110 (signal 1115). The search results may include URIs associated with documents that match the search query. One of the URIs may be associated with a document stored by content server 140.

The user may choose to store the search results in the user's search history stored by URI collection server 150 (signal 1120). Crawler 334, associated with document index server 130, may crawl content server 140 (signal 1130). Crawler 334 may obtain a new URI associated with URI stored in the user's search history (signal 1140). URI updates publisher server 160 may periodically check for URI updates by accessing document index server 130 (signal 1150). URI updates publisher server 160 may obtain a list of URIs that have been updated signal 1160). The obtained list may include the URI associated with the document stored by content server 140.

URI updates publisher server 160 may publish a URI update, which may include a list of URIs that have recently changed. URI collection server 150 (which in this example includes a server that stores search histories) may subscribe to URI updates publisher server 160. Since URI collection server 150 is a subscriber of URI updates publisher server 160, URI collection server 150 may receive the URI update from URI updates publisher server 160 (signal 1170).

URI collection server 150 may update user search histories which include URIs that have changed, as indicated in the received URI update (signal 1180). Thus, URI collection server 150 may update the search history associated with the user of client device 110. When the user of client device 110 accesses the stored search history to retrieve the document stored in content server 140, the search history may store the correct URI for the document (signal 1190). Thus, the user may be able to access the document from the user's search history, even though the URI associated with the document has changed.

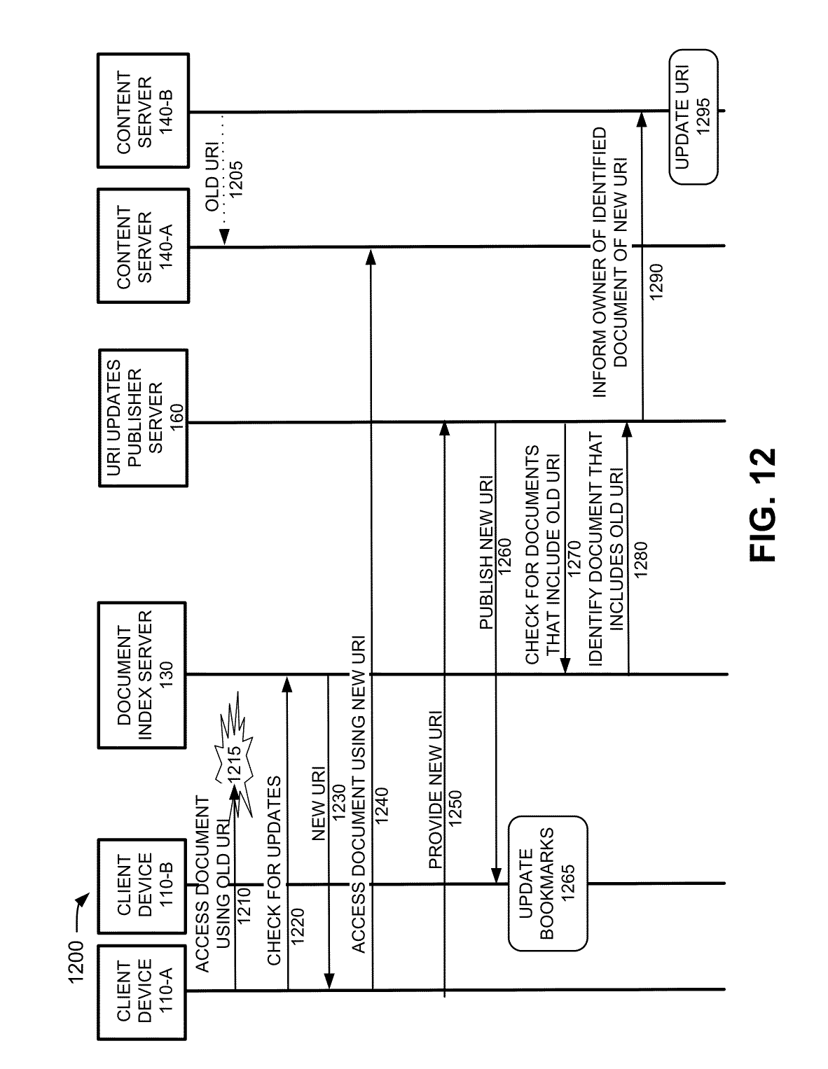

FIG. 12 is a third example 1200 of updating uniform resource identifiers according to an implementation described herein. Example 1200 may include an implementation where an add-on application associated with a browser application (e.g., a toolbar application) reports broken links to URI updates publisher server 160. Example 1200 further illustrates an implementation where URI updates publisher server 160 attempts to inform owners of documents that link to a broken link about the broken link.

Example 1200 may include a browser application client device 110-A accessing a document using an old URI (signal 1210). The old URI may correspond to a broken link and client device 110-A may fail to retrieve the document (item 1215). In response, add-on application 310, associated with the browser application, may check for updates associated with the old URI by accessing document index server 130 (signal 1220) and may retrieve a new URI associated with the document (signal 1230). The browser application may access the document stored at content server 140-A using the new URI (signal 1240).

Furthermore, add-on application 310 may report the broken link to URI updates publisher server 160 and may provide the new URI, received from document index server 130, to URI updates publisher server 160 (signal 1250). In another example, when add-on application 310 detects a broken link, add-on application 310 may report the broken link directly to URI updates publisher server 160, URI updates publisher server 160 may determine a new URI by contacting document index server 130, and URI updates publisher server 160 may provide the new URI to add-on application 310.

URI updates publisher server 160 may publish a URI update and may include the new URI in the published URI update (signal 1260). Client device 110-B may be subscriber of URI publisher server 160 and may receive the URI update. In response, add-on application 310 running on client device 110-B may update the old URI, stored in a bookmark folder, to the new URI (item 1265).

URI updates publisher server 160 may check for documents that include the old URI by contacting document index server 130 (signal 1270). Document index server 130 may provide backlink information for the document associated with the old URI, which may include information about documents that include the old URI (signal 1280). URI updates publisher server 160 may identify an owner of the document that includes the old URI, which in this case may be content server 140-B. Content server 140-B may store a document that includes the old URI (item 1205). URI updates publisher server 160 may determine contact information for content server 140-B and may send a message to content server 140-B, informing content server 140-B about the broken link and providing the new URI (signal 1290). Content server 140-B may update the document by replacing the old URI in the document with the new URI (item 1295).

### CONCLUSION

The foregoing description provides illustration and description, but is not intended to be exhaustive or to limit the implementations to the precise form disclosed. Modifications and variations are possible in light of the above teachings or may be acquired from practice of these implementations.

For example, while series of blocks or signals have been described with regard to FIGS. 5-12, the order of the blocks or signals may be modified in other implementations. Further, non-dependent blocks or signals may be performed in parallel.

Also, certain portions of the implementations may have been described as “component,” “manager,” “monitor,” “crawler,” or “interface” that performs one or more functions. The terms “component,” “manager,” “monitor,” “crawler,” and “interface” may include hardware, such as a processor, an ASIC, or a FPGA, or a combination of hardware and software (e.g., software running on a processor).

Furthermore, while implementations described herein have been described with respect to URIs, other types of resource identifiers may be used. A resource identifier may include any string of characters (e.g., name, network address, identifier, etc.) that uniquely identifies a resource.

It will be apparent that aspects described herein may be implemented in many different forms of software, firmware, and hardware in the implementations illustrated in the figures. The actual software code or specialized control hardware used to implement aspects does not limit the embodiments. Thus, the operation and behavior of the aspects were described without reference to the specific software code—it being understood that software and control hardware can be designed to implement the aspects based on the description herein.

It should be emphasized that the term “comprises/comprising,” when used in this specification, is taken to specify the presence of stated features, integers, steps, or components, but does not preclude the presence or addition of one or more other features, integers, steps, components, or groups thereof.

Even though particular combinations of features are recited in the claims and/or disclosed in the specification, these combinations are not intended to limit the disclosure of the invention. In fact, many of these features may be combined in ways not specifically recited in the claims and/or disclosed in the specification. Although each dependent claim listed below may directly depend on only one other claim, the disclosure of the invention includes each dependent claim in combination with every other claim in the claim set.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

1. A method performed by one or more computer devices, the method comprising:
obtaining, by at least one of the one or more computer devices, a stored uniform resource identifier (URI) associated with a particular resource and associated with a URI collection;
accessing, by at least one of the one or more computer devices, a document index that stores information about canonical URIs,
where the information relates a particular canonical URI to one or more other URIs;
determining, by at least one of the one or more computer devices, whether the particular canonical URI, stored in the document index and associated with the particular resource, differs from the stored URI; and
replacing, by at least one of the one or more computer devices and in the URI collection, the stored URI with the particular canonical URI, when the particular canonical URI differs from the stored URI.

2. The method of claim 1, further comprising:
generating a list of unique URIs from the URI collection;
where obtaining the stored URI includes:
obtaining the stored URI from the generated list of unique URIs;
where determining whether the particular canonical URI differs from the stored URI includes:
determining whether a canonical URI, stored in the document index and associated with a particular URI from the generated list of unique URIs, differs from the particular URI,
the particular URI corresponding to the stored URI; and
where replacing the stored URI with the particular canonical URI includes:
replacing, in the URI collection, the particular URI with the canonical URI, associated with the particular URI, when the canonical URI, associated with the particular URI, differs from the particular URI, and
replacing each instance of the particular URI with the canonical URI in the URI collection.

3. The method of claim 1, where the URI collection includes a bookmark collection stored on a server device,
where the stored URI includes a bookmark in the bookmark collection, and
where replacing the stored URI with the particular canonical URI includes:
replacing, in the bookmark collection, the bookmark with the particular canonical URI when the particular canonical URI differs from the stored URI.

4. The method of claim 1, where the URI collection includes URIs stored in connection with a search history associated with a particular user,
where the URIs, stored in connection with the search history, include the stored URI, and
where replacing the stored URI with the particular canonical URI includes:
replacing, in the URIs stored in connection with the search history, the stored URI with the particular canonical URI when the particular canonical URI differs from the stored URI.

5. The method of claim 1, where the URI collection includes URIs included in messages sent or received by a particular user,
where the URIs, included in the messages, include the stored URI, and
where replacing the stored URI with the particular canonical URI includes:
replacing, in the URIs included in the messages, the stored URI with the particular canonical URI when the particular canonical URI differs from the stored URI.

6. The method of claim 1, where the URI collection includes URIs associated with a discussion group or a message board,
where the URIs, associated with the discussion group or the message board, include the stored URI, and
where replacing the stored URI with the particular canonical URI includes:
replacing, in the URIs associated with the discussion group or the message board, the stored URI with the particular canonical URI when the particular canonical URI differs from the stored URI.

7. The method of claim 1, where the URI collection includes URIs included in a document,
where the URIs, in the URIs included in the document, include the stored URI, and
where replacing the stored URI with the particular canonical URI includes:
replacing, in the URIs included in the document, the stored URI with the particular canonical URI when the particular canonical URI differs from the stored URI.

8. The method of claim 1, further comprising:
reporting the stored URI and the particular canonical URI to a URI updates publishing service, when the particular canonical URI differs from the stored URI.

9. A method performed by one or more server devices, the method comprising:
obtaining, by at least one of the one or more server devices, one or more canonical uniform resource identifiers (URIs) from a document index,
where the one or more canonical URIs have changed since a particular time period;
obtaining, by at least one of the one or more server devices, one or more outdated URIs associated with particular ones of the one or more canonical URIs from the document index;
generating, by at least one of the one or more server devices, a URI update that includes the one or more canonical URIs and the associated one or more outdated URIs; and
providing, by at least one of the one or more server devices, the generated URI update to one or more subscribers to replace the one or more outdated URIs with the one or more canonical URIs.

10. The method of claim 9, where the one or more subscribers include at least one of:
a bookmark server device that stores bookmarks for particular users;
a search history server device that stores search histories for particular users;
a mail server device that stores messages associated with particular users; or
a server device that stores messages associated with a discussion group or message board.

11. The method of claim 9, further comprising:
receiving a report of an outdated URI from a client device; and
adding the reported outdated URI and a canonical URI, associated with the outdated URI, to the URI update.

12. The method of claim 9, further comprising:
identifying a document that includes an outdated URI of the one or more outdated URIs;
obtaining a contact address for a content manager associated with the identified document; and
sending a notification about the outdated URI to the obtained contact address.

13. The method of claim 12, where obtaining the contact address includes:
searching a server device that stores the identified document for a term indicative of the contact address.

14. The method of claim 12, where sending the notification includes:
sending a particular one of the one or more canonical URIs, associated with the outdated URI, to the contact address.

15. A method performed by one or more computer devices, the method comprising:
subscribing, by at least one of the one or more computer devices, to a uniform resource identifier (URI) updates service;
receiving, by at least one of the one or more computer devices, a URI update from the URI updates service,
where the URI update includes an old URI and a new URI associated with the old URI;
determining, by the at least one of the one or more computer devices, whether the old URI is stored in a URI collection associated with the one or more computer devices,
the URI collection including URIs included in search histories associated with users; and
updating, by the at least one of the one or more computer devices, the old URI to the new URI in the URIs included in the search histories included in the URI collection, when the old URI is included in the URIs included in the search histories included in the URI collection.

16. The method of claim 15, where the one or more computer devices include one or more of:
a bookmark server device that stores bookmarks associated with users and the URI collection includes the bookmarks;
a mail server device that stores messages sent or received by users and the URI collection includes URIs included in the messages;
a server device that stores the search histories; or
a server device that stores data feed subscriptions associated with users and the URI collection includes URIs included in the data feed subscriptions,
the method further comprising:
updating the old URI to the new URI in one or more of:
the bookmarks when the old URI is included in the bookmarks,
the URIs included in the messages when the old URI is included in the URIs included in the messages, or
the URIs included in the data feed subscriptions when the old URI is included in the URIs included in the data feed subscriptions.

17. The method of claim 15, further comprising:
identifying other instances of the old URI in other URI collections associated with the one or more computer devices; and
updating the other instances of the old URI to the new URI.

18. A system comprising:
one or more server devices to:
obtain a stored resource identifier associated with a resource identifier collection,
the resource identifier collection including resource identifiers included in a bookmark collection;
access a document index that stores information about canonical resource identifiers,
where the information relates each canonical resource identifier, of the canonical resource identifiers, to one or more other resource identifiers;
obtain, from the document index, a particular canonical resource identifier, of the canonical resource identifiers, that is associated with the stored resource identifier;
determine whether the particular canonical resource identifier differs from the stored resource identifier; and
replace, in the resource identifiers included in the bookmark collection, the stored resource identifier with the particular canonical resource identifier, when the particular canonical resource identifier differs from the stored resource identifier.

19. The system of claim 18, where the one or more server devices are further to:
generate a list of unique resource identifiers from the resource identifier collection,
where, when obtaining the stored resource identifier, the one or more server devices are further to:
obtain the stored resource identifier from the generated list of unique resource identifiers; and
replace each instance of the stored resource identifier with the particular canonical resource identifier in the resource identifier collection.

20. The system of claim 18, where the resource identifier collection includes at least one of:
resource identifiers included in a search history associated with a particular user,
resource identifiers included in messages sent or received by a particular user;
resource identifiers associated with a discussion group or a message board, or
resource identifiers included in a document, and
where, when replacing each instance of the stored resource identifier with the particular canonical resource identifier, the one or more server devices are further to:
replace each instance of the stored resource identifier with the particular canonical resource identifier in at least one of:
the resource identifiers included in the search history,
the resource identifiers included in the messages,
the resource identifiers associated with the discussion group or the message board, or
the resource identifiers included in the document.

21. A system comprising:
one or more server devices to:
obtain one or more canonical uniform resource identifiers (URIs) from a document index,
where the one or more canonical URIs have changed since a particular time period;
obtain one or more outdated URIs associated with particular ones of the one or more canonical URIs from the document index;
generate a URI update that includes the one or more canonical URIs and the associated one or more outdated URIs; and
provide the generated URI update to one or more subscribers to replace the one or more outdated URIs with the one or more canonical URIs in one or more of:
URIs included in a bookmark collection,
URIs included in a search history associated with a particular user,
URIs included in messages sent or received by a particular user,
URIs associated with a discussion group or a message board, or
URIs included in a document.

22. The system of claim 21, where the one or more server devices are further to:
receive a report of an outdated URI from a client device; and
add the outdated URI and a canonical URI, associated with the outdated URI, to the URI update.

23. The system of claim 21, where the one or more server devices are further to:
identify a document that includes at least one of the one or more outdated URIs;
obtain a contact address for a content manager associated with the identified document; and
send a notification about the at least one of the one or more outdated URIs to the obtained contact address.

24. A non-transitory computer-readable medium storing instructions, the instructions comprising:
one or more instructions which, when executed by one or more computer devices, cause the one or more computer devices to subscribe to a uniform resource identifier (URI) updates service;
one or more instructions which, when executed by the one or more computer devices, cause the one or more computer devices to receive a URI update from the URI updates service,
where the URI update includes an old URI and a new URI associated with the old URI;
one or more instructions which, when executed by the one or more computer devices, cause the one or more computer devices to determine whether the old URI is stored in a URI collection associated with the one or more computer devices,
the URI collection including URIs included in a search history associated with a particular user; and
one or more instructions which, when executed by the one or more computer devices, cause the one or more computer devices to update the old URI to the new URI in the URIs included in the search history, when the old URI is included in the URIs included in the search history stored in the URI collection.

25. The non-transitory computer-readable medium of claim 24, where the URI collection further includes one or more of:
URIs included in a bookmark collection;
URIs included in messages sent or received by a particular user;
URIs associated with a discussion group or a message board; or
URIs included in a document, and
where the instructions further comprise:
one or more instructions to update the old URI to the new URI in one or more of:
the URIs included in the bookmark collection when the old URI is included in the URIs included in the bookmark collection,
the URIs included in the messages when the old URI is included in the URIs included in the messages,
the URIs included in the discussion group or the message board when the old URI is included in the URIs included in the discussion group or the message board, or
the URIs included in the document when the old URI is included in the URIs included in the document.

26. The non-transitory computer-readable medium of claim 24, the instructions further comprising:
one or more instructions to identify other instances of the old URI in other URI collections; and
one or more instructions to update the other instances of the old URI to the new URI.
